(19) United States
(12) Patent Application Publication
(10) Pub. No.: US 2010/0201997 A1
(43) Pub. Date: Aug. 12, 2010

(54) METHOD AND SYSTEM FOR THE AUTOMATIC PROCESSING OF PRINTING DATA FOR A PRINTING OPERATION

(76) Inventor: Michael Has, Erding (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/377,148

(22) PCT Filed: Oct. 5, 2007
(86) PCT No.: PCT/EP07/60611

§ 371 Date: Feb. 11, 2009

(30) Foreign Application Priority Data
Oct. 6, 2006 (DE) 10 2006 047 436.8

(51) Int. Cl. G06F 15/00

(52) U.S. Cl. 358/1.9; 358/1.15

(57) ABSTRACT

In a method or system for automatic preparation of print data for a printing process, the print data is imported and subdivided into segments. The segments are analyzed with an image analysis method for automatically determining presentation parameters for the respective segments such that an image content of the respective segments is analyzed for at least one of color depth, contrast, sharpness, brightness, color space, detail richness, or resolution. The print data together with the automatically determined presentation parameters are provided to control the printing process.

### BACKGROUND

The preferred embodiment concerns a method and a system for automatic processing of print data for a printing process.

A method to generate and output print pages is known from EP 1 290 628 B1. In this method a print page that contains multiple blocks is created by means of a first program module, for example a word processing program or a DTP program. Each block contains image data of image elements. A presentation parameter that characterizes the image properties of a block is manually associated with each block. An output unit (for example a printer or a monitor) outputs the image data (or i.e. all data) that describe text, layout and image). For the output of the image data, these are converted block by block, wherein the conversion procedures are established by these presentation parameters of the individual blocks. Multiple such conversion procedures form image processing procedures. They in particular comprise soft focusing, sharp focusing, edge smoothing, font smoothing, segmentation, color depth changing, resolution changing, brightness changing, contrast changing and color intensity changing procedures.

In this method it is achieved that suitable image processing procedures can be automatically selected via the presentation parameters associated with each block by an operator upon creation of the print page. The printing process at a printer is therefore optimized for every single block.

A method to generate and output a document is described in WO 01/77805 A2, in which the document is generated with the aid of a generation program module. The document can be divided up into multiple sections, and a presentation parameter is associated with each section. An output parameter set is established with this presentation parameter. The presentation parameters are manually set by the user. The association of the presentation parameters can also occur with the aid of a program module. The sections of the document are hereby examined for specific character strings. Given correlation of words of a surveyed section, a corresponding presentation parameter is automatically associated with this section with the aid of a logical link.

A method to control the printing of a hard copy arises from EP 0 674 289 B1. The hard copy can comprise at least two elements of the elements (A) text, (B) graphic images, (C) photographic images on one side. These elements are differentiated with the method. Statistics for each different document are collected. Printer-specific controls corresponding to these statistics are generated in order to print the individual elements on the respectively available printers with as optimal a quality as possible. The individual elements are basically differentiated based on their data format. It is also suggested that a “spatial frequency analysis” of a bitmap is conducted to differentiate these elements.

A method with which new attributes that have been assigned to specific blocks in a scanned image can be edited arises from U.S. Pat. No. 5,825,944. Automatically generated attributes should be automatically corrected with this method. These attributes contain the location of the blocks, the size of the data, the type of the image data (text, table, image, photographic image etc.), sub-attributes and pointers to the superordinate or sub-ordinate blocks. The corresponding data are presented in a hierarchical tree, wherein each branch point of the tree corresponds to a block. Since the checking of the attributes occurs manually, here only attributes that are recognized by the user via visual inspection can be set. These attributes primarily describe the type of the data.

The foundations of digital image processing arise from Bernd Jaehne's “Digital Image Processing”, 6th revised edition. In particular, how specific features can be automatically extracted from images is explained in the section III “Feature Extraction”, Page 299-448. How objects in images can be automatically segmented is indicated in Chapter 16, “Segmentation”, Page 449 to 462.

From offset printing it has long been known that, in a larger run, print data to be printed are initially manually analyzed by an operator of the printing device. The operator must possess special experience in the printing field for this and recognize which properties of the document to be printed are relevant for setting the printing device. In printing a map, for example, large, contiguous blue areas that represent oceans or lakes can be printed with relatively low resolution, in contrast to which a black legend or the fine black, red or yellow lines that represent roads and paths should be printed very precisely with high resolution. An experienced print pre-stage service provider also recognizes whether an image should be printed with a sharp focus function or soft focus function, wherein this can also be different from region to region. Furthermore, an experienced printer can conduct the sharpness and contrast adjustment. The print pre-stage service provider executes this adjustment based solely on the visual inspection of the document to be printed and his professional experience, without additional tools.

However, in electrophotographic high-capacity printing it is not possible for an experienced printer to manually check each document to be printed and individually set presentation parameters. This in particular applies for applications in which, although high quantities are printed, the individual print copies differ from one another. Given print jobs in which print data of different sources are assembled that should then be printed immediately, it is not possible to manually check every single print page. However, electrophotographic high-capacity printing systems possess the possibility to control the printing process differently using a plurality of output parameters so that, given a standard setting for a print job, the technical capabilities of the printing device cannot be utilized.

### SUMMARY

For automatic preparation of print data for a printing process it is an object to achieve a specific print output even given an electrophotographic high-capacity print environment.

An additional object is to achieve a method for automatic preparation of print data for a printing process in which the print data are compressed in a high-performance manner for the additional processing of the printing device.

In a method or system for automatic preparation of print data for a printing process, the print data is imported and subdivided into segments. The segments are analyzed with an image analysis method for automatically determining presentation parameters for the respective segments such that an image content of the respective segments is analyzed for at least one of color depth, contrast, sharpness, brightness, color space, detail richness, or resolution. The print data together with the automatically determined presentation parameters are provided to control the printing process.

### BRIEF DESCRIPTION OF THE DRAWINGS

FIG. 1 illustrates a network with a print environment and a print preparation computer on which the method according to the preferred embodiment is executed; and

FIG. 2 shows the method according to the preferred embodiment in a flow diagram.

### DESCRIPTION OF THE PREFERRED EMBODIMENTS

For the purposes of promoting an understanding of the principles of the invention, reference will now be made to the preferred embodiments/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

In the method according to the preferred embodiment for automatic preparation of print data for a printing process, the following steps are executed:
importation of print data,
sub-division of the print data into segments,
analysis of the segments with an image analysis method for automatic determination of presentation parameters for the respective segments, wherein the image content of the segments is analyzed for color depth, contrast, sharpness, brightness, color space, detail richness and/or resolution, and
provision of the print data together with the automatically determined presentation parameters to control a printing process.

According to the preferred embodiment method, the segments are analyzed with an image analysis method. Physical quantities such as the color depth, the sharpness, the color space, the detail richness, the resolution, the contrast and/or the brightness of the image can be determined with such an image analysis method. Semantic contents of the individual segments can also be determined from these physical quantities. Very different semantic contents can hereby be determined. There are very fundamental semantic contents, such as the curve of individual edges and the disposition of individual objects in the segments. A higher level of semantic content is the determination of whether the segments are text, images (with the exception of photographic images), or photographic images. By photographic images, what are understood are images with greyscales or color scales that are typically generated by an exposure with a camera. However, such images can also be synthetically produced.

In a next highest level of semantic content it is determined whether the segments are maps, technical/scientific diagrams (graphs), plans, newspapers, invoices, personalized advertising letters, landscape photography, product photography or portrait photography.

Digital image processing has progressed so far that such semantic contents can be determined automatically. For example, reference is made in this regard to Bernd Jähne, “Digital Image Processing”, 6th revised and expanded edition, Springerverlag (ISBN 3-540-24035-7 or ISBN 978-3-540-24035-8), Section III “Feature Extraction”. In this it is stated in detail how features such as greyscale values, edges, objects and the like can be extracted from images.

The presentation parameters can on the one hand be the immediate physical quantities or properties of the image that are obtained by means of the image analysis method; on the other hand, they can also comprise the semantic contents. The presentation parameters are thus parameters that describe segments of the print data to be printed in terms of content in such a manner that these are suitable to control a printing process in the corresponding print environment.

By an “image analysis method”, what is understood is a method with which physical properties (for example contrast, brightness etc.) are extracted from the image from the image data (pixel data or vector data). In such an image analysis method, the semantic content of an image can also be automatically extracted. However, the automatic extraction of semantic content is not a necessary feature of the image analysis method.

By using such an image analysis method, presentation parameters can be associated with print data from different sources. There thus exists no need that presentation parameters are always associated upon generation of the print data. Rather, in an electrophotographic high-capacity print environment it is such that the print data often originate from different sources and are only assembled into the print jobs in the print server, or in a print processing station that is upstream of the print server. In such an environment it is extremely difficult to ensure that all generators of print data provide the print data with presentation parameters.

It is in fact disclosed in WO 01/77805 A2 that a specific section of a document can be automatically associated with a presentation parameter, wherein this occurs using predetermined character strings that are contained in the text of this document. In this known method, only already-present contents are thus used in order to associate presentation parameters. However, no images are subjected to an image analysis method. However, only the use of an image analysis method ensures that reliable presentation parameters can be associated with the desired precision with arbitrary image data that can originate from the most different sources.

The provision of the print data together with the automatically determined presentation parameters can occur both via storage of these print data together with the presentation parameters in a print server and via direct relaying of the print data and of the presentation parameters to the controller of a printing apparatus.

If the print data are analyzed at a print server or at another computer to generate print data, and the presentation parameters are automatically generated by means of an image analysis method, it is thus appropriate to store the print data and the presentation parameters on the corresponding computer or print server. These print data can then be relayed to a printing apparatus at a suitable point in time. It is also possible to link multiple such print data analyzed in advance into a common print job, wherein the presentation parameters of the individual print data are adopted in the print job. The control of the printing apparatus then occurs as it is known from WO 01/77805 A2 or EP 1 290 628 B1, via generation of output parameters using the presentation parameters with which the printing apparatus is directly controlled.

On the other hand, it is also possible to relay the print data with the automatically determined presentation parameters directly to the controller of the printing apparatus without caching, wherein the control of the printing process can then also occur directly using the presentation parameters, thus without generation of output parameters.

A basic principle of the present preferred embodiment is that a printing apparatus is adjusted by means of the presentation parameters automatically obtained with an image analysis method.

The automatic association of the presentation parameters also allows the presentation parameters to respectively be generated with a different precision for different print environments. By a print environment, what is understood is a system with at least one print server and multiple printers. A print environment can also comprise multiple print servers. If a print environment has a plurality of different printing apparatuses that can print documents in different qualities, it is then appropriate to generate the presentation parameters more precisely (i.e. with a finer categorization) since then the printing process can correspondingly be controlled more precisely. In contrast to this, for print environments with a few printers that can be controlled only with a limited output parameter set, it is not necessary to generate such a precise division of the presentation parameters.

If the print data are analyzed for different print environments, it is appropriate to automatically generate at least those presentation parameters with which the output parameters are generated that can be used in all print environments or with which all print environments with common setting capabilities can be controlled.

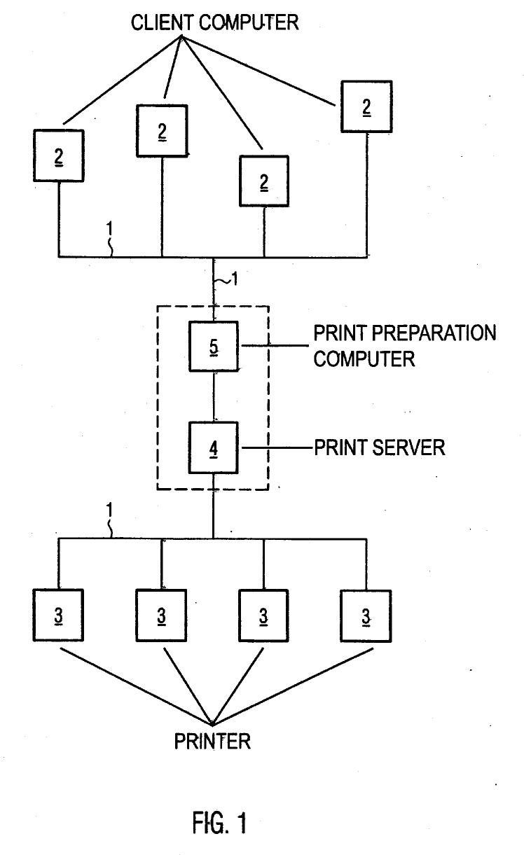

FIG. 1 shows a section of a network 1. Multiple client computers 2 are arranged in the network 1. Programs to generate print data are stored on the client computers 2 such that such programs can be executed. Such programs are, for example, text programs, character programs, DTP programs or other programs to generate print data. These programs can be typical workstation programs that generate print data in one of the typical printer languages such as Postscript or PCL. However, they can also be professional application programs that generate print data in a document processing data stream, for example AFP.

The print data should be printed out at a printer 3 via the network 1. In the network 1, multiple printers 3 are provided that receive their print data via a print server 4. A print preparation computer 5 is arranged between the client computers 2 and the print server 4. The print preparation computer 5 receives the print data of the different client computers 2 and prepares the print data for relaying to the print server 4. The print preparation computer 5 can also store print data that can be assembled with other print data into a print job at a later point in time. The print preparation computer 5 can execute different image processing procedures depending on which print servers or server it should supply with print data.

According to the preferred embodiment, a computer program to execute an image processing procedure is provided at the print preparation computer 5, with which image processing procedure presentation parameters are automatically associated with the print data.

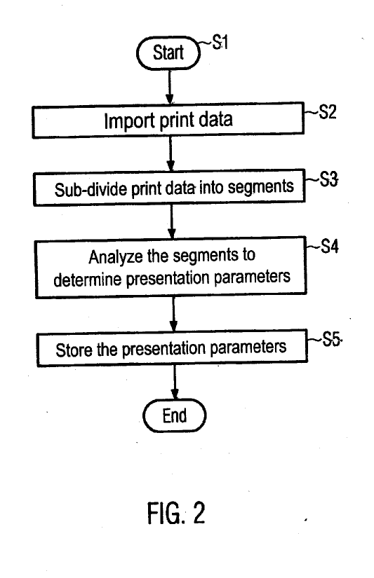

The method according to the preferred embodiment is presented in the flow diagram shown in FIG. 2. It begins with Step S1. Print data that are transmitted from a client computer to the print preparation computer 5 are imported into the print preparation computer 5 in Step S2. The print data are subdivided into segments. For example, this sub-division of the segments can occur such that each print page forms a single segment. However, the print data often contain no per-page sub-division (for example given a long text that is sub-divided into printer-specific pages depending on the printer on which it is printed). Since no information about the printer exists at the print preparation computer 5, a print-specific processing of the print files is not yet possible. The print data are then sub-divided into segments according to a different rule. It can also be that a specific set of incoming print data is treated as a single segment.

Print data that have regions with different image data types are advantageously sub-divided into segments, wherein each segment comprises a specific image data type. Different image data types are, for example, text data, images in vector graphics or images in pixel graphics or bitmaps. Each region that comprises such an image data type is identified as a separate segment.

The segments can be blocks with straight-line boundary edges. However, they are normally arbitrarily shaped sections of the print data. The segmentation occurs according to known methods. For example, reference is made in this regard to Bernd Jähne, “Digital Image Processing”, 6th revised and expanded edition, Springerverlag (ISBN 3-540-24035-7 or ISBN 978-3-540-24035-8-3), Chapter 16 “Segmentation”. Described herein are image analysis methods with which an image can automatically be segmented and that are suitable for the present method for automatic preparation of print data and generation of presentation parameters.

However, it is also possible to adopt a data structure already contained in the print data and to accordingly sub-divide the segments. It is hereby possible that different image data types are also provided within a segment.

The individual segments are subjected to an image analysis method (Step S4) with which at least one or more physical quantities of the respective image segment are automatically determined. These physical quantities are, for example, the brightness, the contrast, the object-dependent resolution, the detail richness of an image, the sharpness and the color dynamic of the image. By “object-dependent resolution”, what is understood is the resolution that is required in order to be able to present the image content without information loss. The small and finer the individual objects or elements of the image, the higher the object-dependent resolution.

Different methods in the prior art are available for extraction of this physical quantity (see for example Bernd Jähne, “Digitale Bildverarbeitung” I.c.). These physical quantities can be directly stored as presentation parameters for the respective segments. They can also be analyzed further, which is described in detail further below.

In addition to the physical quantities extracted by means of the image analysis method, parameters intrinsically contained in the data set of the print data can also be drawn upon for generation of the presentation parameters. Such intrinsically contained parameters are, for example, the resolution of a bitmap file, which is to be differentiated from the object-dependent resolution and which specifies in which resolution the pixels of the bitmap file are stored. An additional parameter intrinsically contained in the data set is the color depth, which can assume typical values of 1 bit, 10 bits, 12 bits. The data sets also contain most specifications about the respective image data type so that these data can be directly extracted from the print data and do not always need to be extracted by means of the image analysis method.

These data intrinsically contained in the data structure of the data set can also be stored as presentation parameters.

An additional analysis for semantic content can be conducted on the basis of these physical quantities and the parameters intrinsically contained in the data structure (which are designated in the following as intrinsic parameters). In the present exemplary embodiment, semantic contents of three levels are differentiated, namely of a base level, a middle level and an upper level.

The base level comprises fundamental semantic content such as, for example, edges and individual objects in the respective segments. Different methods are known for detection of edges and objects.

The middle level of the semantic content comprises texts, images (with the exception of photographic images) and photographic images. Photographic images are images with predominant greyscales or color curves and few individual lines. The other images are images with no greyscales or color curves, or only greyscales or color curves with small dynamic ranges.

Such images often have thin drawn lines.

In the upper level, the images and photographic images are again sub-divided according to semantic content. For example, the images comprise maps, business graphics, technical/scientific documents (graphs) and plans.

In the upper level the photographic images are subdivided into, for example, landscape images, portraits and product images.

There is a level of semantic content still superordinate to this in which multiple segments of the print data are assembled that together form a contiguous print data unit that is designated as a work. Such works are, for example, invoices, personalized advertising letters or newspapers. For example, it is known to print newspapers from specific publishers in a foreign country in a smaller run in a special format on electrophotographic printers so that the subscribers to this newspaper can also be provided with the corresponding newspaper copies, even abroad. The quality requirements for such a newspaper printing are relatively low, such that these global presentation parameters have effects on all segments. In contrast to this, average quality requirements are required for invoices, contrary to which high quality demands are placed on the printout with personalized advertising letters so that the advertising letter can be successful.

The type of the work (which is also designated as a target genre) requires predetermined processing methods to which the printer is correspondingly to be set. The target genre thus represents a presentation parameter in the sense of the present preferred embodiment.

Using some examples it is subsequently explained how the presentation parameters are automatically discovered.

Given maps, the colors blue (oceans and lakes) and green normally form larger contiguous areal regions, in contrast to which the colors yellow, red and black are provided with narrow lines (paths, streets and tracks or, respectively, small red areas for communities and cities). This feature structure can be automatically detected and established as a map.

Portrait photos are detected such that a head of the portrayed person is detected as an object. This image object has typical features in shape and color. The same applies for business graphics and technical/scientific diagrams.

Mathematical methods such as Fourier analysis, expert systems, filters and/or neural networks are applied individually or in combination to extract the physical quantities of the print data as well as to determine the semantic contents. Furthermore, fractal image analysis methods with which self-similar segments of an image are extracted can be used to extract the physical quantities of the print data as well as to determine the semantic contents. The Fourier analysis is primarily used to determine frequency distributions with regard to the brightness and/or color of the images. These analyses are applied either to the entire image or to individual color separations. Multiple feature images of a segment can be generated in the implementation of these analysis methods. Such a feature image is, for example, an image which is obtained by deriving the greyscale values of the output image. Such an image is often very advantageous for determination of the edges. The individual presentation parameters listed above can be obtained using multiple different feature images of a segment.

There are intrinsic parameters (for example the color space black-and-white, HLC, full color space) that possess corresponding presentation parameters that are obtained by means of the image analysis, for example the color distribution with which the quantity or, respectively, the frequency of the respective primary colors is designated in a specific color segments.

As is already known from WP 1 290 628 B1 and WO 01/77895 A2, using the presentation parameters output parameters in the print server 4 or in the printer 3 can be established that allow a segment-optimized and printer-specific output of the print data. These two documents are incorporated by reference into the present application.

For example, if the presentation parameter is the “map” parameter, the color blue can be printed with low resolution, contrary to which the colors red, yellow and black that reflect the streets and labels should be printed very precisely with high resolution. Since the visual impression for the color black is significantly stronger than for the color yellow, it can be appropriate to print the color black with higher resolution than the color yellow.

The presentation parameters automatically generated according to the preferred embodiment are in principle independent of the printer. The print data so provided with presentation parameters can be cached and relayed via a print server to a printer for print-out at an arbitrary point in time.

In the framework of the preferred embodiment it is also possible to generate the presentation parameters automatically so that they are directly suitable to control a printer. The intervening step of the conversion of the presentation parameters into output parameters can hereby be omitted, and the print data and the corresponding presentation parameters can be relayed directly to the printer without caching or be generated in this in order to produce an optimal setting of the available print parameters in the printer.

The analysis of the print data can also be executed such that a set of segments with corresponding presentation parameters are stored in a database, wherein the presentation parameters are associated with a segment in that this new segment is compared with the example segments present in the database and, in the event that the new segment corresponds within a certain degree with an example segment present in the database, the presentation parameters of the existing example segment with which it corresponds are associated with the new segment. This method can also be implemented in combination with the image analysis method described above, wherein—if a new segment is not analyzed via such a comparison since there are no sufficiently similar example segments in the database—it is incorporated into the database together with its presentation parameters. The method hereby additively learns, whereby the analysis times can be shortened with increasing use of the method since now more example segments are available.

It can also be appropriate to generate the presentation parameters with different precision depending on the respective present print environment. Print environments that have printing apparatuses of the most different capacity levels with regard to quality and throughput and therefore comprise as a whole a very large spectrum of adjustment capabilities of the printing process can react significantly more precisely to presentation parameters. Here it makes sense to analyze the print data in a very detailed and exact manner and to determine very precise presentation parameters. In contrast to this, given print environments with less similar printers, it can be sufficient when only printing parameters at the base level and middle level are determined, for example.

Since the presentation parameters are automatically determined with the method according to the preferred embodiment, it is not necessary to manually generate the presentation parameters in the creation of the print data. Print data from arbitrary sources can thus be processed with the method according to the preferred embodiment. The method according to the preferred embodiment also allows large quantities of print data with different contents and/or different job tickets to be printed with an electrophotographic printing system. With the preferred embodiment, the flexibility of electrophotographic printing systems (i.e. the capability to print each side with a different subject) combines with quality features of conventional offset printing, wherein neither a delay nor a limitation of the flexibility of the printing process results due to the fast automatic generation of the presentation parameters.

The present preferred embodiment is not limited to the presentation parameters listed in the example above. The presentation parameters explained above merely serve to explain the preferred embodiment.

In a development of the preferred embodiment, the properties of the print data obtained by means of the automatic image analysis discussed above are used in order to parameterize the print data. The print data can hereby be stored in a compressed form. This compression of the print data represents an independent preferred embodiment.

The individual color separations are hereby analyzed with the image analysis method, and contiguous areas of similar color are automatically determined. Such areas can simply be parameterized via specification of boundary lines and/or of the color or of the color curve. For example, the color curve can be represented by means of a polynomial function.

The contiguous areas or regions can be determined by means of a Fourier analysis or a random walk method.

The color transition in the region of the boundary lines is advantageously analyzed, and color curve smoothing functions essentially transversal to the boundary lines are used in order to avoid artificial color jumps in the region of the boundary lines.

In an advantageous development of this method, not only contiguous areas or regions are parameterized; rather, parameterized image data are stored together with processing instructions that indicate how the parameterization has been implemented. If the parameterization of the image data should be canceled again at a later point in time, the image data can be brought into an original form significantly more precisely under consideration of the processing instructions.

If the image data should be subjected to a specific preprocessing before the parameterization, processing instructions describing these processing processes can also be stored together with the parameterized image data. This information can also be very helpful in the reproduction of the original format.

The preferred embodiment can be briefly summarized as follows:

The preferred embodiment concerns a method and a system for automatic preparation of print data for a printing process. Presentation parameters for print data are automatically generated with the method according to the preferred embodiment. The generation of the presentation parameters occurs with the aid of an image analysis method (among other things) so that physical quantities that are associated with the print data as presentation parameters directly or after additional analysis are extracted from the print data. Using the presentation parameters, output parameters with which the printing process is controlled can be determined according to known methods.

Although a preferred exemplary embodiments have been shown and described in detail in the drawings and in the preceding specification, they should be viewed as purely exemplary and not as limiting the invention. It is noted that only the preferred exemplary embodiments have been shown and described, and all variations and modifications that presently and in the future lie within the protective scope of the invention should be protected.

1-26. (canceled)

27. A method for automatic preparation of print data for a printing process, comprising the steps of:
importing the print data;
sub-dividing the print data into segments;
analyzing the segments with an image analysis method for automatically determining presentation parameters for the respective segments such that an image content of the respective segments is analyzed for at least one of color depth, contrast, sharpness, brightness, color space, detail richness, or resolution; and
providing the print data together with the automatically determined presentation parameters to control the printing process.

28. A method according to claim 27 wherein a specific image analysis method is selected depending on a respective data type of the segment.

29. A method according to claim 27 wherein a Fourier analysis or frequency analysis is used as an image analysis method to determine the resolution of the print data of the respective segment.

30. A method according to claim 27 wherein an expert system is used as an image analysis method, to which expert system are provided as input values the print data of the segment, and parameters determined by means of pre-analysis methods, with which respective print data the presentation parameters are associated.

31. A method according to claim 27 wherein a neural network is used as an image analysis method, to which neural network are provided as input values the print data of the segment and parameters determined by means of pre-analysis methods, with which respective print data the presentation parameters are associated.

32. A method according to claim 27 wherein a fractal image analysis method is used as an image analysis method with which self-similar segments can be extracted.

33. A method according to claim 27 wherein information contained in a job ticket are used to determine the presentation parameters or render them more precisely.

34. A method according to claim 27 wherein before the analysis of the print data, the print data are broken down into specific color separations, wherein image analysis methods are individually applied to the color separations.

35. A method according to claim 34 wherein the color separations are represented by means of polynomial curves and a respective set of support points.

36. A method according to claim 27 wherein the print data, together with the automatically determined presentation parameters, are stored on an apparatus automatically associated with a printer.

37. A method according to claim 36 wherein different print data are combined with their respective presentation parameters into a print job and are printed out at the printer.

38. A method according to claim 36 wherein the presentation parameters are provided in output parameters to control the printing process.

39. A method according to claim 27 wherein the automatically determined presentation parameters are used to directly control the printing process.

40. A method according to claim 27 wherein the sub-division of the print data into segments occurs automatically by means of the image analysis method.

41. A method to automatically prepare print data of a printing process, comprising the steps of:
importing the print data;
breaking down the print data into predetermined color separations;
analyzing the color separations with an image analysis method to automatically determine contiguous areas of similar color; and
compressing the print data wherein the contiguous areas are parameterized.

42. A method according to claim 41 wherein the contiguous areas are determined by means of Fourier analysis or a random walk method.

43. A method according to claim 41 wherein boundary lines of the contiguous areas are parameterized.

44. A method according to claim 43 wherein color curves within the contiguous areas are parameterized.

45. A method according to claim 44 wherein color curve smoothing functions running approximately transversal to the boundary lines are used on the boundary lines.

46. A method according to claim 41 wherein processing instructions that specify how the parameterized areas have been determined are stored together with the compressed print data.

47. A method according to claim 41 wherein processing instructions that describe a possible pre-processing of the print data are stored together with the parameterized areas.

48. A method according to claim 41 wherein the parameters generated in the compression are directly used as inputs for an image analysis.

49. A system for automatic preparation of print data for a printing process, comprising:
a computer on which a computer readable medium is provided having a program for performing the steps of:
importing the print data;
subdividing the print data into segments;
analyzing the segments with an image analysis method for automatically determining presentation parameters for the respective segments such that an image content of the respective segments is analyzed for at least one of color depth, contrast, sharpness, brightness, color space, detail richness, or resolution; and
providing the print data together with the automatically determined presentation parameters to control the printing process.

50. A system according to claim 49 wherein the computer is arranged in a network to transmit print data to one or more printers.

51. A system according to claim 50 wherein the computer comprises a print preparation computer or a print server.

52. A system according to claim 49 wherein the computer comprises a controller of a printer.
